(19) United States
(12) Patent Application Publication
(10) Pub. No.: US 2010/0199926 A1
(43) Pub. Date: Aug. 12, 2010

(54) Sling Leash

(76) Inventors: Randall McCullough, Deerfield Beach, FL (US); Angelo Castello, Fort Lauderdale, FL (US)

Correspondence Address: FELDMAN GALE, P.A., 1700 Market Street, Suite 3130, Philadelphia, PA, 19103, US

(21) Appl. No.: 12/435,255

(22) Filed: May 4, 2009

Related U.S. Application Data
(60) Provisional application No. 61/151,120, filed on Feb. 12, 2009.

(51) Int. Cl. A01K 27/00

(52) U.S. Cl. 119/795; 119/769

(57) ABSTRACT

The present invention is generally described as a method and apparatus for handling an animal, including but not limited to a domesticated dog, and more particularly is a leash apparatus made primarily of a durable strand material, such as nylon webbing, that facilitates the activity of walking or handling the animal.

### CROSS REFERENCE TO RELATED APPLICATIONS

This application claims the benefit under 35 U.S.C. §119(e) of U.S. Provisional Application No. 61/151,120, filed on Feb. 12, 2009, the complete disclosure of which is incorporated herein by reference in its entirety.

### FIELD OF THE INVENTION

The present invention relates to devices and methods for handling and controlling animals, including but not limited to domesticated dogs.

### BACKGROUND OF THE INVENTION

Traditional methods of walking or controlling an animal often present difficulties and dangers to the animal's handler. When utilizing current leashes and other similar animal control devices, the animal often has leverage or control advantages over the handler, especially when the animal has been excited or startled. Existing devices used to walk or handle an animal only offer a basic handle design, usually consisting of a simple strap that is formed in a loop and reattached to itself. These simple existing designs focus the point of control in the leash handle, and consequently, in the handler's single hand. Particularly when a handler is trying to control an animal of significant size and strength, the handler often tries to modify the basic leash or similar control device by employing awkward, ineffective, and often-times dangerous methods such as wrapping the leash around the back of the handler's arm multiple times in an attempt to gain leverage over the animal by distributing the force of the animal to other regions of the handler's arm such as the forearm and bicep areas.

Manually wrapping the strap of a leash around the arm or other body parts, however, can create a tourniquet-like effect causing pain and the restriction of blood flow. If the leash or other control device is inappropriately wrapped around the handler's wrist, there can also be substantial injury to the wrist when the animal exerts a sudden force on the leash.

Other existing leashes that are not necessarily manual modifications, but rather, leashes specifically designed to provide the handler with greater leverage over the animal, are likewise awkward, ineffective, and potentially dangerous. For example, devices that wrap around the handler's waist, torso, or lower extremities, such as those described by U.S. Pat. No. 6,932,027, issued to Whitney; U.S. Pat. No. 6,626,131, issued to Moulton III; U.S. Pat. No. 6,450,129, issued to Flynn; U.S. Pat. Nos. 5,950,569 & 5,842,444, issued to Perrulli; and U.S. Pat. No. 5,806,466, issued to Pintor, can cause injury or pain to the handler's lower back when the animal exerts a sudden force on the leash to which the handler's waist, torso, or lower extremities are integrally tethered. If the force of the animal is great enough, the sudden movement may even cause the handler to slip and fall, and sustain even greater injury.

There is, therefore, a long unsolved need for a leash and method of handling an animal, including but not limited to domesticated dogs, that facilitates walking or handling the animal by providing the handler with greater control and leverage over the animal without utilizing a device or method that could potentially injure the handler.

### SUMMARY OF THE INVENTION

The present invention is generally directed to a method and apparatus to safely facilitate walking or handling an animal, including but not limited to a domesticated dog, by providing the handler with greater leverage and control over the animal. In one embodiment of the present invention, the handler's hand grips a handle, preferably cushioned and adjustable; the handle is connected to a standard leash or similar device, and is also connected to an arm pad, which is also preferably cushioned and adjustable. The arm pad can be pulled back and positioned around the rear area of the handler's upper arm near the triceps region, thereby allowing the handler to maintain a substantially 90 degree angle, or “sling position,” when handling the animal.

The sling position evenly distributes any force exerted by the animal throughout the entire arm of the handler and allows the handler to effectively counter the force of the animal by utilizing the stronger regions of the handler's arm, such as the handler's forearm, bicep, and shoulder regions. This provides the handler with significantly greater leverage and control over the animal without the risks associated with straps tightening around or restricting the handler's arm, waist, torso, or lower extremities.

It is therefore an object of the present invention to provide a safer and more maneuverable method and apparatus for any handler that wishes to walk or handle an animal. It is a further object of the present invention to provide a much needed and improved method and apparatus for handlers of professional work dogs, such as K-9 units and other law enforcement dogs that are known to exert a great amount of force on the handler.

### BRIEF DESCRIPTION OF THE DRAWINGS

FIG. 1 depicts a perspective view of the leash apparatus.

FIG. 2 depicts a handler gripping the handle of the leash apparatus in a conventional position.

FIG. 3 depicts a handler gripping the handle of the leash apparatus in a sling position.

FIG. 4 depicts a close-up view of the connection between the handle and arm pad of the leash apparatus.

FIGS. 5 and 5a depict close-up views of alternative connections between the handle and arm pad of the leash and arm pad apparatus.

FIG. 6 depicts another embodiment of the leash apparatus incorporating a second grab handle that can be engaged by the handler's second free arm for added control and leverage of the animal; FIG. 6a depicts the strand that forms the grab handle lying flat against the main leash strand of the leash apparatus when not engaged by the handler.

### DETAILED DESCRIPTION OF THE PREFERRED EMBODIMENTS

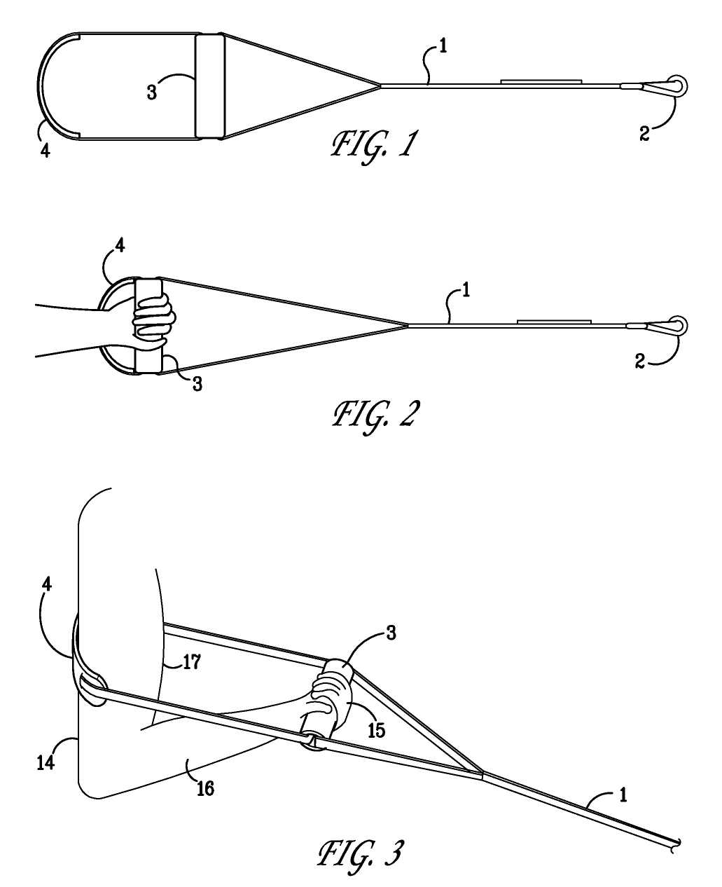

With reference to FIG. 1, the leash apparatus of the present invention is generally comprised of a main leash strand 1 preferably having a substantially flat geometric configuration and preferably made of a durable, flexible, webbed material such as nylon. Other possible materials may include rope, leather, chain or any other material suitable for the purpose. The cross-section of the main leash strand can also be of any geometric configuration. Preferably, main leash strand 1 can stretch to a length of approximately six feet from hook assembly 2 to handle 3. Longer and shorter lengths are also acceptable. Preferably, the width of main leash strand 1 is approximately between one half of an inch and two inches; and even more preferably between three fourths of an inch and one inch.

As further depicted in FIG. 1, hook assembly 2 is attached to a first end of main leash strand 1. Hook assembly 2 is preferably configured to attach directly to a neck collar or harness worn by a dog or animal using any configuration suitable for the purpose. Hook assembly 2 can be made of any hard metal, such as stainless steel, but can also be made of any durable material suitable for the purpose. Although many types and sizes of hook assemblies are suitable for the device, including but not limited to swivel-and-bolt style combinations, in a preferred embodiment of the present invention, hook assembly 2 is approximately three inches in length, one inch in width, and has a squared-end opening whereby a first end of the main leash strand 1 passes through the opening and attaches to the main leash strand by stitching or other attachable means, thereby securing the main leash strand 1 to the hook assembly 2.

As shown in FIG. 2, handle 3 can be gripped by the handler in a conventional handling position, particularly when the animal is in a docile state and is not exerting any sudden or excessive force on the handler. Preferably, handle 3 is approximately four and one half inches long and approximately one inch wide, but can also be any dimension suitable for the purpose; handle 3 can be made out of rubber, neoprene, foam, or any other material suitable for the purpose; and handle 3 can have any cross-section geometric configuration that permits the handler to grip handle 3. In yet another preferred embodiment of the present invention, handle 3 is further comprised of a rigid reinforcement member that is passed through a hollow opening in handle 3 so that the handle does not bend or flex from the force exerted by the animal or handler. The rigid reinforcement member is preferably tubular in shape, but can have any geometric cross-sectional configuration suitable for the purpose. The rigid reinforcement member can also be made out of PVC, plastic, metal, or any other durable material suitable for the purpose.

With reference to FIGS. 1 through 5, handle 3 is further connected to arm pad 4. Arm pad 4 can be made out of foam, neoprene or any other material suitable for the purpose. Preferably, arm pad 4 is substantially rectangular, approximately six inches in length, and approximately two and one half inches in width, but can also have any geometric configuration or dimension suitable for the purpose.

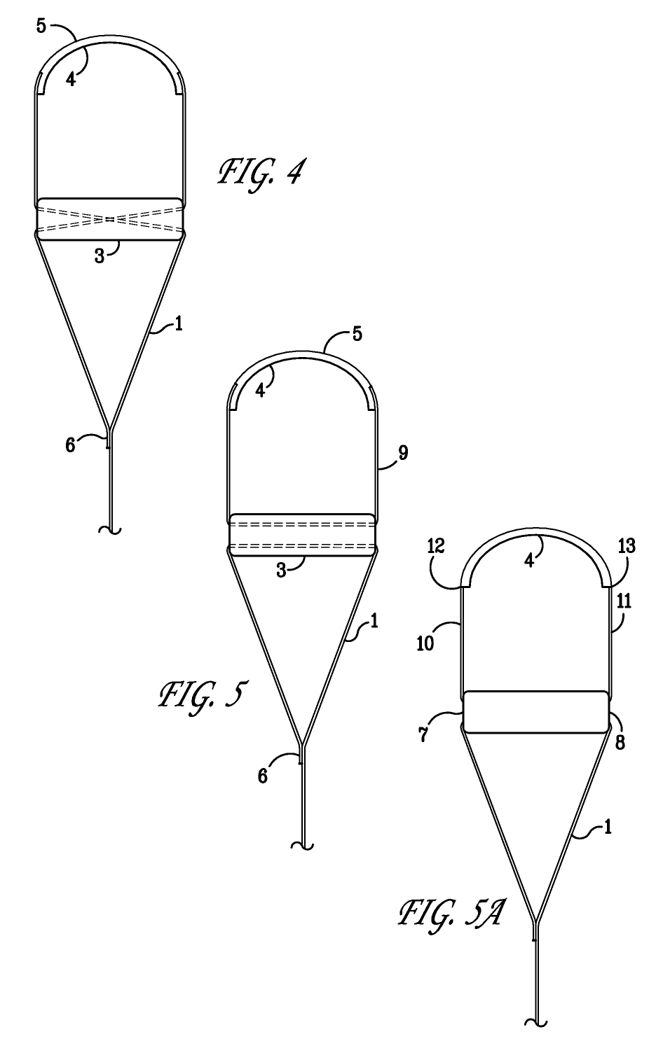

As shown in FIG. 3, arm pad 4 can be positioned on the handler's upper arm near the triceps region 14 while the handler's hand 15 grips handle 3. In this sling position, the handler's arm naturally maintains a substantially 90 degree angle, thereby evenly distributing any force exerted by the animal throughout the entire arm and shoulder area of the handler and allowing the handler to effectively counter the force of the animal by utilizing the stronger regions of the handler's arm, such as the handler's forearm region 16 and biceps region 17.

With reference to FIG. 4, in a preferred embodiment of the present invention, main leash strand 1 extends through a hollow opening in handle 3; extends through sleeve 5 in arm pad 4; once again extends through the hollow opening of handle 3; and a second end 6 of main leash strand 1 attaches, by stitching or any other suitable attaching means, to a section of main leash strand 1, preferably between the hook assembly 2 and handle 3.

With further reference to the configuration depicted in FIG. 4, when the handler grips handle 3 and simultaneously pulls arm pad 4 away from the handle, the length of main leash strand 1 between handle 3 and arm pad 4 increases, while the length of main leash strand 1 between handle 3 and the second end 6 of main leash strand 1 decreases. Conversely, when the handler grips handle 3 and the main leash strand is simultaneously pulled from its first end, the length of main leash strand 1 between handle 3 and arm pad 4 decreases, while the length of main leash strand 1 between handle 3 and the second end 6 of main leash strand 1 increases. This configuration thereby allows the handler to adjust the length of main leash strand 1 between handle 3 and arm pad 4 to the approximate length of the handler's forearm.

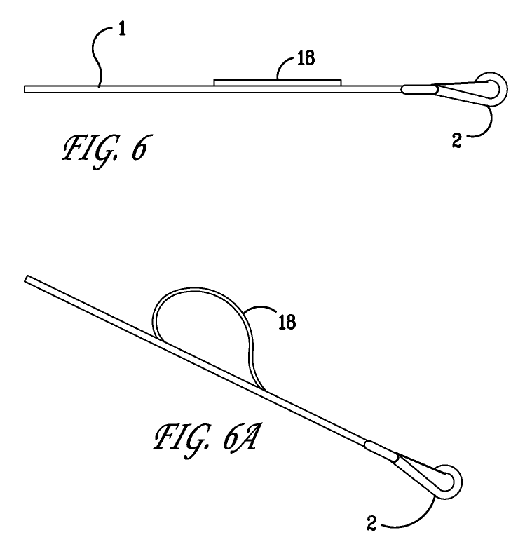

As shown in FIG. 5, in an alternative embodiment of the present invention, main leash strand 1 traverses a hollow opening of handle 3, and a second end of main leash strand 6 attaches, by stitching or any other suitable attaching means, to a section of main leash strand 1, preferably between the hook assembly 2 and handle 3. Alternatively, as depicted in FIG. 5a, handle 3 is secured to main leash strand 2 by attaching a second leash strand and third leash strand to the main leash strand 1 so that the second leash strand, third leash strand, and main leash strand 1 form a substantially triangular configuration when handle 3 is gripped by the handler. In this embodiment, second leash strand attaches to a first end 7 of handle 3, and third leash strand attaches to a second end 8 of handle 3. With further reference to FIG. 5, arm pad 4 connects to handle 3 by a connecting strand 9 extending through arm pad sleeve 5 and handle 3. Connecting strand 9 can be made of a flexible or elastic material or any other material suitable for the purpose. Alternatively, as depicted in FIG. 5a, two or more connecting strands 10 and 11 attach to a first end 12 and a second end 13 of arm pad 3 and also attach to first and second ends 7 and 8 of handle 3.

As shown in FIG. 6a, in another embodiment of the present invention, main leash strand 1 is further comprised of grab handle 18. In this embodiment, when the handler's first hand has engaged handle 3, whether in a conventional handling position or in a sling position, the handler's second hand can engage grab handle 18 and thereby increase the handler's leverage and control over the animal. As depicted in FIG. 6, in a preferred embodiment of the present invention, grab handle 18 will lay flat against the main leash strand 1 when the handler does not desire to engage grab handle 18.

Although details of specific implementations and embodiments are described above, such details are intended to satisfy statutory disclosure obligations rather than to limit the scope of the following claims. Thus, the invention is defined by the claims, not limited by the specific features described above. The invention is claimed in any form that falls within the proper scope of the appended claims, appropriately interpreted in accordance with the doctrine of equivalents.

What is claimed is:

1. A leash for controlling an animal comprising:
a main leash strand;
a handle attached to said main leash strand, said handle being configured for gripping by a handler; and
an arm pad connected to said handle, said arm pad being configured for positioning around a handler's upper arm.

2. The leash of claim 1 further comprising first and second ends of said main leash strand and a hook assembly, said hook assembly being attached to said first end of said main leash strand, said hook assembly being configured to attach to a harness or collar worn by an animal.

3. The leash of claim 2, said connection between said arm pad and said handle and said attachment between said handle and said main leash strand further comprising said main leash strand extending through a hollow opening in said handle, further extending through a sleeve in said arm pad, further extending a second time through said hollow opening, and said second end attaching to said main leash strand between said hook assembly and said handle.

4. The leash of claim 2, said attachment between said handle and said main leash strand further comprising said main leash strand extending through a hollow opening in said handle, and said second end of said main leash strand attaching to said main leash strand between said hook assembly and said handle.

5. The leash of claim 2, further comprising a second leash strand and a third leash strand attached to said main leash strand so that said second leash strand, said third leash strand, and said main leash strand form a substantially triangular configuration when said handle is gripped by a handler, said second leash strand further attached to a first end of said handle and said third leash strand further attached to a second end of said handle.

6. The leash of claim 2, said connection between said arm pad and said handle further comprising one or more connecting strands extending through said handle and said arm pad.

7. The leash of claim 2, said connection between said arm pad and said handle further comprising one or more connecting strands being attached to a first end and a second end of said arm pad.

8. The leash of claim 7, said one or more connecting strands being attached to a first end and a second end of said handle.

9. The leash of claim 2 further comprising a grab handle attached to said main leash strand between said hook assembly and said handle, said grab handle capable of being engaged by a second of hand of a handler.

10. The leash of claim 1, said handle further comprising a hollow opening and a rigid reinforcement member inserted through said hollow opening of said handle.

11. A method of controlling an animal utilizing a leash having a main leash strand, said main leash strand having a first and second end; a hook assembly attached to said first end; a handle attached to said main leash strand, said handle being configured for gripping by a handler; and an arm pad connected to said handle, said arm pad being configured for positioning around a handler's upper arm, said method comprising the steps of,
gripping said handle;
pulling said arm pad around the upper arm of said handler;
controlling said animal whereby said handler's upper and lower arm maintains a substantially 90 degree angle.

12. The method of claim 11, said connection between said arm pad and said handle and said attachment between said handle and said main leash strand further comprising said main leash strand extending through a hollow opening in said handle, further extending through a sleeve in said arm pad, further extending a second time through said hollow opening, and said second end attaching to said main leash strand between said hook assembly and said handle; said method further comprising the steps of,
adjusting said arm pad around said upper arm of said handler by increasing the length of said main leash strand between said arm pad and said handle, and decreasing the length of said main leash strand between said handle and said second end of said main leash strand.

13. The method of claim 11 further comprising the step of engaging a grab handle attached to said main leash strand to assist in controlling the animal.
